(19) United States
(12) Patent Application Publication
(10) Pub. No.: US 2011/0212684 A1
(43) Pub. Date: Sep. 1, 2011

(54) DATA TRANSMISSION AND RECEPTION METHOD IN COOPERATIVE COMMUNICATION SYSTEM

(75) Inventors: Junyoung Nam, Daejeon (KR); Heesoo Lee, Daejeon (KR); Young-Jo Ko, Daejeon (KR); Jae-Young Ahn, Daejeon (KR)

(73) Assignee: Electronics and Telecommunications Research Institute, Daejeon (KR)

(21) Appl. No.: 13/126,989

(22) PCT Filed: Oct. 30, 2009
(86) PCT No.: PCT/KR2009/006362

§ 371 Date: Apr. 29, 2011

(30) Foreign Application Priority Data
Oct. 30, 2008 (KR) 10-2008-0107306
Dec. 30, 2008 (KR) 10-2008-0136894
Feb. 3, 2009 (KR) 10-2009-0008469

(51) Int. Cl. H04B 7/14

(52) U.S. Cl. 455/7

(57) ABSTRACT

A data transmission and reception method in a cooperative communication system is provided. The data transmission method of a base station in a cooperative communication system includes: generating a first code word for cooperative transmission and a second code word for direct transmission to a mobile station; and transmitting a signal including one or more of the first and second code words to a relay equipment for cooperative transmission and the mobile station. The first and second words are independent from each other.

### BACKGROUND OF THE INVENTION

1. Field of the Invention

Exemplary embodiments of the present invention relates to a data transmission and reception method in a wireless communication system; and, more particularly, to a data transmission and reception method in a cooperative communication system.

2. Description of Related Art

In order to support a higher transmission rate than that provided by the third generation (3G) mobile communication systems and extend service coverage, the development of the fourth generation (4G) mobile communication systems is being demanded. Research institutes and companies of many advanced countries are already competing in technology development for the standardization of 4G mobile communication systems.

The 4G mobile communication systems operating in radio frequency (RF) bands have a limited range of transmission rates and service regions due to a high path loss. To solve such a problem, a signal transmission scheme using multi-hop has been recently researched. In the scheme using multi-hop, a repeater equipment may be used to cooperatively transmit data to a mobile station or mobile station such that a path loss is reduced to implement high-speed data communication, and a service region may be extended so as to transmit a signal to a mobile station in a remote position from an eNode B or base station. In the multi-hop relay system, that is, the cooperative communication system, communication between two nodes is performed through a serial wireless link among a transmitter serving as a base station, relay equipments and a receiver serving as a mobile station.

The multi-hop relay technology may be roughly classified into an amplify & forward scheme and a decode & forward scheme. The amplify & forward scheme is a scheme in which a relay equipment simply amplifies an RF signal received from a transmitter and then forwards the amplified RF signal to a receiver. In the decode & forward scheme, a relay equipment demodulates and decodes a received signal, and then modulates and encodes the signal to cooperatively transmit to a receiver. Furthermore, the multi-hop relay technology may be divided into a full duplex scheme and a half duplex scheme. In the full duplex scheme, a relay equipment receives a signal from a transmitter, and relays the signal to a receiver at the same time and at the same frequency. In the half duplex scheme, a relay equipment performs transmission and reception at different times or at different frequencies.

In the cooperative communication system, a theoretical maximum transmission speed, that is, a maximum channel capacity depends on block Markov coding (hereinafter, referred to as BMC) of “Thomas M. Cover”. However, the BMC is only a theoretical method, and a code word transmitted from a transmitter, that is, data has a dependent relation. Therefore, a relay equipment has difficulties in re-encoding, and a receiver has difficulties in decoding. Accordingly, the scheme is difficult to implement in an actual cooperative communication system.

### SUMMARY OF THE INVENTION

An embodiment of the present invention is directed to a data transmission and reception method which provides a high-level data transmission rate in a cooperative communication system and which may be easily implemented.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a data transmission method of a base station in a cooperative communication system includes: generating a first code word for cooperative transmission and a second code word for direct transmission to a mobile station; and transmitting a signal including one or more of the first and second code words to a relay equipment for cooperative transmission and the mobile station. The first and second words are independent from each other.

In accordance with another embodiment of the present invention, a data transmission and reception method of a relay equipment in a cooperative communication system includes: receiving a first signal transmitted from a base station, the first signal including one or more of a first code word for cooperative transmission and a second code word for direct transmission to a mobile station, and transmitting a second signal including the first code word to the mobile station. The first and second code words are independent from each other.

In accordance with another embodiment of the present invention, a data reception method of a mobile station in a cooperative communication system includes: receiving a first signal transmitted from a base station, the first signal including one or more of a first code word for cooperative transmission and a second code word for direct transmission; and receiving a second signal including the first code word from a relay equipment which cooperatively transmits the first signal. The first and second code words are independent from each other.

In accordance with another embodiment of the present invention, a data transmission method of a base station in a cooperative communication system includes: performing resource or time scheduling; allocating resources or transmission times of links among the base station, a relay equipment and a mobile station in accordance with the scheduling; and transmitting data to the relay equipment and the mobile station, respectively, depending on the allocated resources and transmission times.

### BRIEF DESCRIPTION OF THE DRAWINGS

FIG. 1 is a diagram explaining a cooperative communication system in accordance with embodiments of the present invention.

FIG. 2 is a flowchart explaining a data transmission method of a base station 101 in accordance with an embodiment of the present invention.

FIG. 3 is a flowchart explaining a data transmission and reception method of a relay equipment 103 in accordance with another embodiment of the present invention.

FIG. 4 is a flowchart explaining a data reception method of a mobile station 105 in accordance with another embodiment of the present invention.

FIG. 5 is a flowchart explaining a data transmission method of the base station 101 in accordance with another embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

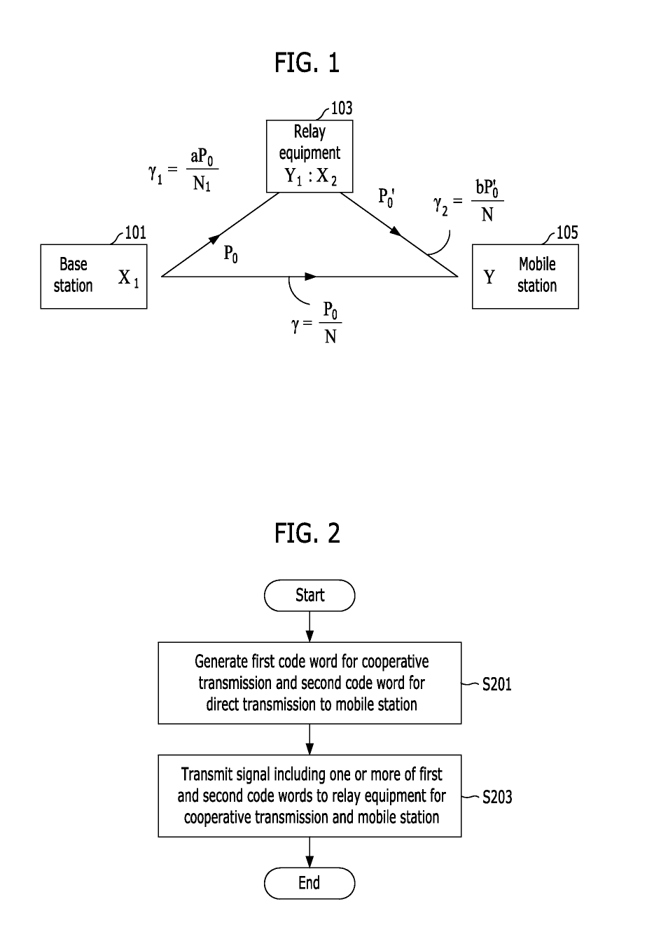

FIG. 1 is a diagram explaining a cooperative communication system in accordance with embodiments of the present invention.

Referring to FIG. 1, the cooperative communication system includes a base station 101, a relay equipment 103, and a mobile station 105. FIG. 1 and the following drawings show a case in which the relay equipment 103 is a relay node. However, the relay equipment 103 in accordance with the embodiments of the present invention may be a base station of cells in accordance with Cooperative Multipoints Tx/Rx (CoMP) for cooperative transmission among multiple cells of the 3rd Generation Partnership Project Long Term Evolution (3GPP LTE) standard. For example, a signal transmitted by the base station 101 of a first cell may be cooperatively transmitted by a base station of a second cell in the vicinity of the first cell. Furthermore, FIG. 1 and the following drawings show a case in which links among the base station 101, the relay equipment 103, and the mobile station 105, that is, wireless channels are Additive White Gaussian Noise (AWGN) channels.

In FIG. 1, P₀ and P₀′ represent an average power of signals transmitted by the station 101 and the relay equipment 103, respectively, and r represents a signal-to-noise ratio (SNR) of the link between the station 101 and the mobile station 105, between the station 101 and the relay equipment 103, or between the relay equipment 103 and the mobile station 105. Furthermore, a and b represent channel gains of the links between the station 101 and the relay equipment 103 and between the relay equipment 103 and the mobile station 105, respectively, X₁ and X₂ represent signals transmitted by the station 101 and the relay equipment 103, respectively, and Y₁ and Y represent signals received by the relay equipment 103 and the mobile station 105, respectively.

The base station 101 transmits a preset average power P₀ of signal to the relay equipment 103 and the mobile station 105. The relay equipment 103 for cooperative transmission amplifies and re-encodes the signal transmitted from the base station 101, and then transmits the amplified and re-encoded signal to the mobile station 105 at a preset average power P₀′. That is, the base station 101 in the cooperative communication system transmits a signal for cooperative transmission to the relay equipment 103 and directly transmits a signal to the mobile station 105.

Hereafter, a data transmission and reception method in accordance with the embodiments of the present invention will be described in more detail with reference to the drawings.

FIG. 2 is a flowchart explaining a data transmission method of the base station 101 in accordance with an embodiment of the present invention.

Referring to FIG. 2, the data transmission method in accordance with the embodiment of the present invention starts from a step S201.

At the step S201, the base station 101 generates a first code word for cooperative transmission and a second code word for direct transmission to the mobile station 105. The first and second code words are independent from each other. That is, the base station 101 divides data into two parts, and then generates the first and second code words independent from each other by encoding the two parts into separate code words. The code words may be selected from all codebooks including a Gaussian codebook, a binary codebook, and so on, and may be Physical Downlink Control Channel (PDCCH) and Physical Downlink Shared Channel (PDSCH) data blocks.

At a step S203, the base station 101 transmits a signal including one or more of the first and second code words to the relay equipment 103 for cooperative transmission and the mobile station 105. More specifically, the base station 101 may transmit a signal including both of the first and second code words to the relay equipment 103 and the mobile station 105, or may transmit signals including one or both of the code words to the relay equipment 103 and the mobile station 105, respectively, depending on the design of the cooperative communication system.

In accordance with a first example of the embodiment of the present invention, the base station 101 may transmit a signal including the first and second code words to the relay equipment 103 and the mobile station 105 at the step S203. In accordance with a second example of the embodiment of the present invention, the base station 101 may transmit a signal including the first and second code words to the mobile station 105 and a signal including the first code word to the relay equipment 103 at the step s203.

In the first example of the embodiment of the present invention, the first code word includes a plurality of code words having different indexes which are allocated depending on transmission times. That is, different indexes are allocated to the code words (code blocks) depending on transmission times. For example, a code word to which an index i+1 is applied represents a code word which is to be transmitted at the next transmission time of a code word to which an index i is allocated.

As described above, the first code word is a code word for cooperative transmission, and the relay equipment 103 receives the first code word and then amplifies or re-encodes the received first code word to transmit to the mobile station 105. That is, the first code word for the relay equipment 103 includes code words having different indexes. For example, the relay equipment 103 may receive the first code word including code words to which indexes i and i+1 are allocated, and the mobile station 105 may receive the first and second code words having an index i+1. In this case, the relay equipment 103 may re-encode the first code word to which the index i+1 is allocated, and then transmit the re-encoded first code to the mobile station 105.

In the second example of the embodiment of the present invention, the base station 101 transmits signals to the relay equipment 103 and the mobile station 105, respectively, using different frequencies or different transmission times. For example, the base station 101 may transmit a signal to the mobile station 105 using a frequency f1, and transmit a signal to the relay equipment 103 using a frequency f2. Furthermore, the base station 101 may transmit a signal to the mobile station 105 at a transmission time t1, and transmit a signal to the relay equipment 103 at a transmission time t2.

In the second example of the embodiment of the present invention, since the signal transmitted to the relay equipment 103 includes only the first code word, the index allocated to the first code word included in the signal transmitted to the relay equipment 103 is different from those allocated to the first and second code words included in the signal transmitted to the mobile station 105.

In accordance with the embodiment of the present invention, as the independent code words are used to transmit the signals to the relay equipment 103 and the mobile station 105, it is possible to provide a cooperative communication system which may guarantee a high-level data transmission rate and may be easily implemented. The data transmission rate is related to a channel capacity indicating the amount of data transmitted through a channel. As an additional code word such as the first code word is transmitted through the relay equipment 103, a larger amount of data may be transmitted to the mobile station 105. Furthermore, since the first and second code words are independent from each other, an implementation of the cooperative communication system may be easily facilitated. The data transmission rate in accordance with the embodiment of the present invention will be described below through equations.

The data transmission method in accordance with the embodiment of the present invention may further include receiving channel information from the mobile station 105 or the relay equipment 103. At the step S203, the base station 101 may generate a signal to be transmitted using channel information. The channel information may include state information and phase information of a wireless channel. For example, the mobile station 105 may estimate a channel using a pilot signal of a received signal, and then transmit the channel information to the base station 101. As the base station 101 may use the channel information to generate a signal whose phase is controlled, the signal received by the mobile station 105 may be coherently combined. The coherent combining may increase the data transmission rate in accordance with the embodiment of the present invention, and the data transmission rate in accordance with the coherent combining will be described below through equations.

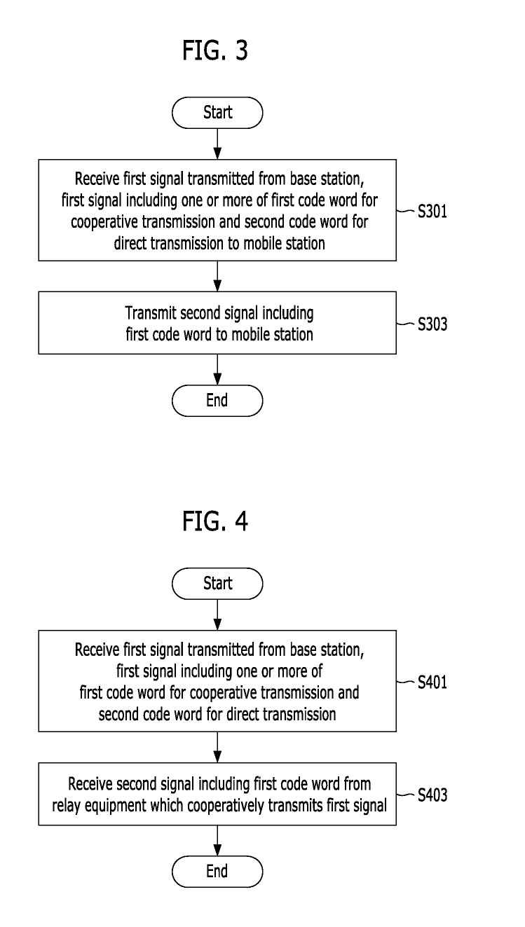

FIG. 3 is a flowchart explaining a data transmission and reception method of the relay equipment 103 in accordance with another embodiment of the present invention.

Referring to FIG. 3, the data transmission and reception method of the relay equipment 103 starts from a step S301.

At the step S301, the relay equipment 103 receives a first signal transmitted from the base station 101, the first signal including one or more of a first code word for cooperative transmission and a second code word for direct transmission to the mobile station. As described above, the first and second code words are independent from each other. In accordance with the first and second examples of the embodiment of FIG. 2, the relay equipment 103 may receive a signal transmitted from the base station 101, the signal including both of the first and second code words or only the first code word.

At a step S303, the relay equipment 301 transmits a second signal including the first code word to the mobile station 105. The first code word included in the second signal may be re-encoded by the relay equipment 103. Although receiving a transmitted signal including both of the first and second code words, the relay equipment 103 re-encodes the first code word for cooperative transmission and then transmits the re-encoded first code word to the mobile station 105.

The first code word included in the signal of the base station 101 which is transmitted to the relay equipment 103 may include a plurality of code words having different indexes which are allocated depending on transmission times. That is, data which the base station 101 is to transmit to the mobile station 105 at a transmission time i+1 may be previously received by the relay equipment 103 at a transmission time i. Then, the relay equipment 103 may transmit the received data to the mobile station 105 at the transmission time i+1.

The data transmission and reception method of the relay equipment 103 in accordance with the embodiment of the present invention may further include receiving channel information from the mobile station 105. As the relay equipment 103 may generate the second signal using the channel information, the received signal may be coherently combined in the mobile station 105.

FIG. 4 is a flowchart explaining a data reception method of the mobile station 105 in accordance with another embodiment of the present invention.

Referring to FIG. 4, the data reception method of the mobile station 105 in accordance with the embodiment of the present invention starts from a step S401.

At the step S401, the mobile station 105 receives a first signal transmitted from the base station 101, the first signal including one or both of a first code word for cooperative transmission and a second code word for direct transmission. For example, the mobile station 105 may receive the first signal including both of the first and second code words or only the second code word from the base station 101. When the base station 101 transmits the first signal including only the second code to the mobile station 105, an implementation of the mobile station 105 for decoding may be facilitated.

At a step S403, the mobile station 105 receives a second signal transmitted from the relay equipment 103 which cooperatively transmits the first signal, the second signal including the first code word. The mobile station 105 may decode the first and second code words included in the received first and second signals to reproduce data.

The data reception method of the mobile station 105 in accordance with the embodiment of the present invention may further include transmitting channel information to the base station 101 or the relay equipment 103 such that the base station 101 or the relay equipment 103 may generate a signal to be transmitted using the channel information.

Hereafter, the data transmission and reception method in accordance with the embodiment of the present invention will be described in more detail using the following equations and FIG. 1.

In accordance with the first example of the embodiment of the present invention which has been described in FIG. 2, the base station 101 transmits a signal including first and second code words independent from each other to the relay equipment 103 and the mobile station 105. The signal transmitted by the base station 101 may be expressed as Equation 1 below.

x_{1,i}=\sqrt{αP₀}(\sqrt{β}wᵢ+{square root over ( β̅sᵢ₊₁)+\sqrt{α̅P₀}sᵢ Eq. 1

where 0≦α, β≦1, and α̅=1−α. Furthermore, s represents the first code word which is cooperatively transmitted by the relay equipment 103, and w represents the second code word which is not cooperatively transmitted but directly transmitted to the mobile station 105 only by the base station 101. It may be seen that when the coefficients of the first and second code words are squared and added, power of the transmitted signal becomes P₀. As described above, i represents an index which corresponds to a preset transmission time and is allocated to a code word, and sᵢ₊₁ represents a code word which is to be transmitted at the next transmission time after a code word sᵢ is transmitted. That is, the base station 101 transmits the code words sᵢ₊₁ and sᵢ at the same transmission time i. The indexes allocated to code words included in the first code word may differ depending on the design of the cooperative communication system.

For example, Equation 1 may be modified into x_{1,i}=\sqrt{αP₀}(\sqrt{β}wᵢ+{square root over ( β̅sᵢ)+\sqrt{α̅P₀}sᵢ₋₁ or x_{1,i}=\sqrt{αP₀}(\sqrt{α}wᵢ+{square root over ( α̅ᵢ₊₁)+\sqrt{α̅P₀}sᵢ.

Depending on a wireless channel state, the relay equipment 103 receives a signal expressed as Equation 2 below from the base station 101.

y_{1,i}=\sqrt{αP₁}(\sqrt{β}wᵢ+{square root over ( β̅sᵢ₊₁)+\sqrt{α̅P₁}sᵢ+n_{1,i} Eq. 2

where n represents noise, and P₁=aP₀. As described above, since the first code word transmitted by the base station 101 includes the code words sᵢ₊₁ and sᵢ, the relay equipment 103 previously receive a first cord word corresponding to the index of a code word which is to be transmitted. That is, the relay equipment 103 previously receives the first code word sᵢ₊₁ corresponding to the transmission time i+1, at the transmission time i. Therefore, the relay equipment 103 may re-encode the first code word at the transmission time corresponding to the current index using the previously-transmitted first code word, and then transmit the re-encoded first code.

More specifically, when data transmission rates Rₛ₁ and R_{w1} of the first and second code words of the link between the base station and the relay equipment satisfy Equation 4 below, the relay equipment 103 may encode the first and second cord words.

$${R}_{w 1} \leq C ( \frac{αβ {P}_{1}}{α \overline{β} {P}_{1} + {N}_{1}} ) , {R}_{s 1} \leq C ( \frac{α \overline{β} {P}_{1}}{{N}_{1}} ) , {R}_{w 1} + {R}_{s 1} \leq C ( \frac{α {P}_{1}}{{N}_{1}} ) \qquad Eq . 3$$

where C represents a channel capacity. The channel capacity is determined depending on a signal-to-noise ratio (SNR) in the receiver side (C=log₂(1+SNR)).

As described above, the relay equipment 103 receives the signal expressed as Equation 2, and transmits a signal to the mobile station 105, the signal including the first code word expressed as Equation 4 below.

x_{2,i}=\sqrt{P₀′}sᵢ Eq. 4

The mobile station 105 receives a signal expressed as Equation 5 below by the signals transmitted by the base station 101 and the relay equipment 103. In Equation 5, P₂=bP₀′ and n represents noise.

yᵢ=\sqrt{αP₀}(\sqrt{β}wᵢ+{square root over ( β̅sᵢ₊₁)+\sqrt{α̅P₀}sᵢ+\sqrt{P₂}sᵢ+nᵢ Eq. 5

When it is assumed that the first code word is coherently combined, the data transmission rate of the first code word may be expressed as Equation 6 below. As described above, the base station 101 and the relay equipment 103 may transmit a signal using channel information such that the received signal is coherently combined. That is, the base station 101 and the relay equipment 103 previously control the phases of the links between the base station and the mobile station and between the relay equipment and the mobile station using the channel information. Therefore, the base station 101 and the relay equipment 103 may transmit a signal such that the received signal is coherently combined.

$$C ( \frac{\overline{α} {P}_{0} + {P}_{2} + 2 \sqrt{\overline{α} {P}_{0} {P}_{2}}}{α {P}_{0} + N} ) \qquad Eq . 6$$

In Equation 5, it may be seen that the indexes i and i+1 appear at the same time and the first code word sᵢ is included in a received signal yᵢ₋₁ of the mobile station 105 corresponding to the previous index i−1. That is, since the received signal yᵢ₋₁ of the mobile station 105 including the first code word sᵢ is previously received, the received signal yᵢ₋₁ of the mobile station 105 may be expressed as Equation 7 below, in which the first code word sᵢ is removed from Equation 5.

yᵢ₋₁=\sqrt{αP₀}(\sqrt{β}wᵢ+{square root over ( β̅sᵢ)+nᵢ₋₁ Eq. 7

The received signal expressed as Equation 5 and the received signal expressed as Equation 7 may be subjected to Minimum Mean Squared Error (MMSE) combining, that is, RX combining. The data transmission rate of the first code word in accordance with the MMSE combining may be expressed as Equation 8 below.

$${R}_{s 2} \leq C ( \frac{\overline{α} {P}_{0} + {P}_{2} + 2 \sqrt{\overline{α} {P}_{0} {P}_{2}}}{α {P}_{0} + N} + \frac{α \overline{β} {P}_{0}}{αβ {P}_{0} + N} ) \qquad Eq . 8$$

It may be checked that the data transmission rate in accordance with the coherent combining is higher than the transmission rate in accordance with the MMSE combining, due to

$$\frac{α \overline{β} {P}_{0}}{αβ {P}_{0} + N}$$

### of Equation 8.

The data transmission rate of the second code word may be expressed as Equation 9, when it is based on a list decoding scheme. Alternatively, the data transmission rate of the second code word may be exposed as Equation 10, when it is based on a general successive decoding scheme.

$$\begin{matrix}{R}_{w 2} \leq C ( \frac{α {P}_{0}}{N} ) & Eq . 9 \\ {R}_{w 2} \leq C ( \frac{αβ {P}_{0}}{N} ) & Eq . 10\end{matrix}$$

Hereafter, the data transmission and reception method in accordance with the second example of the embodiment of the present invention, which has been described with reference to FIG. 2, will be described in more detail.

Signals transmitted by the base station 101 and the relay equipment 103 may be expressed as Equation 11 below. In Equation 11, X_{1,i} represents a signal which the base station 101 transmits to the mobile station 105, X_{3,i} represents a signal which the base station 101 transmits to the relay equipment 103, and X_{2,i} represents a signal which the relay equipment 103 transmits to the mobile station 105. As described above, the base station 101 transmits a signal including the first and second code words to the mobile station 105 and a signal including the first code word to the relay equipment 103. At this time, the signals X_{1,i} and X_{3,i} are transmitted at a frequency f1, and the signal X_{2,i} is transmitted at a frequency f2. Since the base station 101 transmits only the signal X_{2,i} at the frequency f2, the base station 101 may reduce the use of frequency resources than when transmitting the signals at the frequency f1. In Equation 11, \tilde{s}ᵢ₊₁ represents a code word which is re-encoded in accordance with the frequency f2. The relay equipment 103 may re-encode the code word received from the base station 101, and transmit the re-encoded code word to the mobile station 105.

x_{1,i}=\sqrt{αP₀}wᵢ+\sqrt{α̅P₀}ᵢ

x_{3,i}=\sqrt{P₀}\tilde{s}ᵢ₊₁

x_{2,i}=\sqrt{P₀′}sᵢ Eq. 11

As described above, the base station 101 may transmit signals to the relay equipment 103 and the mobile station 105 at different transmission times. At this time, the transmitted signals may be expressed as Equation 12 below. In Equation 12, X_{1,t1} represents a signal which the base station 101 transmits to the relay equipment 103 at a transmission time t1, X_{1,t2} represents a signal which the base station 101 transmits to the mobile station 105 at a transmission time t2, and X_{2,t2} represents a signal which the relay equipment 103 transmits to the mobile station 105 at a transmission time t2. The relay equipment 103 may re-encode a code word received from the base station 101, and then transmit the re-encoded code word to the mobile station.

x_{1,t1}=\sqrt{P₀}\tilde{s}ᵢ₊₁

x_{1,t2}=\sqrt{αP₀}wᵢ+\sqrt{α̅P₀}sᵢ

x_{2,t2}=\sqrt{P₀′}sᵢ Eq. 12

In the second example of the embodiment of the present invention, which has been described with reference to FIG. 2, the base station 101 and the relay equipment 103 may generate a signal to be transmitted using channel information such that the received signal is coherently combined.

In the data transmission method in accordance with the embodiment of the present invention, signals including only one code word, for example, the second code word may be transmitted to the relay equipment 103 and the mobile station 105. At this time, the transmitted signals of the base station 101 and the relay equipment 103 may be expressed as Equation 11 below.

x_{1,i}=\sqrt{αP₁}wᵢ+\sqrt{α̅P₁}wᵢ₋₁

x_{2,i}=\sqrt{P₂}wᵢ₋₁ Eq. 13

The received signals of the relay equipment 103 and the mobile station 105 may be expressed as Equation 14 below.

y_{1,i}=\sqrt{αP₁}wᵢ+\sqrt{α̅P₁}wᵢ₋₁+n_{1,i}

yᵢ=\sqrt{αP₀}wᵢ+\sqrt{α̅P₀}wᵢ₋₁+\sqrt{P₂}wᵢ₋₁+nᵢ Eq. 14

As described above, the base station 101 may receive channel information from the mobile station 105 and transmit a signal such that the received signal is coherently combined or MMSE-combined.

The data transmission rate in accordance with the coherent combining is expressed as Equation 15 below.

$${R}^{*} \leq {max}_{0 \leq α \leq 1} min \{ C ( \frac{α {P}_{1}}{{N}_{1}} ) , C ( \frac{\overline{α} {P}_{0} + {P}_{2} + 2 \sqrt{\overline{α} {P}_{0} {P}_{2}}}{α {P}_{0} + N} ) \} \qquad Eq . 15$$

where

$$C ( \frac{α {P}_{1}}{{N}_{1}} )$$

represents a transmission rate of the link between the base station and the relay equipment, and

$$C ( \frac{\overline{α} {P}_{0} + {P}_{2} + 2 \sqrt{\overline{α} {P}_{0} {P}_{2}}}{α {P}_{0} + N} )$$

represents a transmission rate for the received signal of the mobile station 105. Although the data transmission rate is not higher than those in accordance with the first and second examples of the embodiment of the present invention, only one code word may be used to implement the cooperative communication system. Therefore, the implementation may be facilitated.

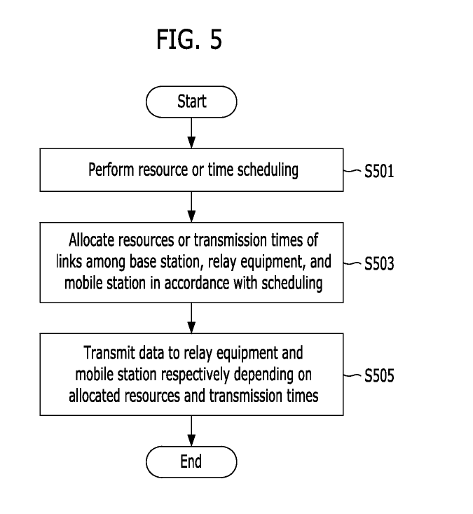

FIG. 5 is a flowchart explaining a data transmission method of the base station 101 in accordance with another embodiment of the present invention.

Referring to FIG. 5, the data transmission method in accordance with the embodiment of the present invention starts from a step S501.

At the step S501, the base station 101 performs resource or time scheduling. That is, the base station 101 performs the scheduling such that optimal times or resources are allocated to the links between the base station 101 and the relay equipment 103, between the base station 101 and the mobile station 105, and between the relay equipment 103 and the mobile station 105. At this time, the base station 101 may perform the scheduling only on the link between the relay equipment 103 and the mobile station 105 so as not to have an effect upon an existing scheme of Hybrid Automatic Repeat Request (H-ARQ). The H-ARQ refers to a scheme which reduces repeat requests from a mobile station side to a base station to increase a transmission rate of packet data, the repeat requests frequently occurring due to a poor wireless channel environment or the like.

When performing the resource or time scheduling, the base station 101 may use channel information to perform the scheduling depending on an SNR or Signal to Interference plus Noise Ratio (SINR) of the link between the base station 101 and the relay equipment 103, between the base station 101 and the mobile station 105, or between the relay equipment 103 and the use terminal 105. That is, the base station 101 may increase or reduce resources to be allocated to the link between the base station 101 and the mobile station 105 depending on the SNR or SINR of the link between the base station 101 and the mobile station 105 by using the channel information fed back from the mobile station 105, and transmit a part of data using the link between the base station 101 and the mobile station 105. Furthermore, the base station 101 may increase or reduce resources to be allocated to the link between the base station 101 and the relay equipment 103 depending on the SNR or SINR of the link between the base station 101 and the relay equipment 103. Therefore, the resources allocated to the link between the base station 101 and the relay equipment 103 may be prevented from excessively increasing. Furthermore, since the base station 101 transmits data to the mobile station 105 and the relay equipment 103 at the same time, the data transmission rate may increase.

At a step S503, the base station 101 allocates resources of the links among the base station 101, the relay equipment 103, and the mobile station 105 in accordance with the resource or time scheduling. That is, the base station 101 may allocate resources of the links between the base station 101 and the relay equipment 103, between the base station 101 and the mobile station 105, and between the relay equipment 103 and the mobile station 105 in accordance with the resource or time scheduling.

At a step S505, the base station 101 transmits data to the relay equipment 103 and the mobile station 105, respectively, depending on the allocated resources. The data may be the above-described first and second code words. The base station 101 may transmit data to the relay equipment 103 and the mobile station 105, respectively, at different transmission times, the data depending on the resources allocated in accordance with the scheduling. For example, the base station 101 may allocate a part of data to the link between the base station 101 and the mobile station 104 in accordance with the resource and time scheduling, and transmit the allocated data to the relay equipment 103 and the mobile station 105, respectively, at different transmission times.

Although FIG. 5 shows an example of the centralized scheduling in which the base station 101 performs scheduling, distributed scheduling by the relay equipment 103 may be performed. In this case, information in accordance with the distributed scheduling of the relay equipment 103 may be transmitted to the base station 101.

The data transmission method described in FIG. 5 will be described in more detail with reference to FIG. 1 and the following equations.

When it is assumed that signals transmitted by a base station and a relay equipment in a general cooperative transmission system are expressed as Equation 16 below, signals transmitted by the base station 101 and the relay equipment 103 in accordance with the scheduling of the base station 101 may be expressed as Equation 17 below.

x_{1,t1}=\sqrt{P₁}wᵢ

x_{2,t2}=\sqrt{P₂}\tilde{w}ᵢ Eq. 16

x_{1,t1}=\sqrt{P₁}wᵢ

x_{1,t2}=\sqrt{αP₁}uᵢ

x_{2,t2}=\sqrt{α̅P₁}\tilde{w}ᵢ Eq. 17

where x_{1,r1}=\sqrt{P₁}wᵢ represents a signal which the base station 101 transmits to the relay equipment 103 at a transmission time t1, x_{1,t2}=\sqrt{αP₁}uᵢ represents a signal which the base station 101 transmits to the mobile station 105 at a transmission time t2 depending on resources allocated to the link between the base station 101 and the mobile station 105 in accordance with the scheduling of the base station 101, and \tilde{w}ᵢ represents data into which the relay equipment 103 re-encode data wᵢ in accordance with the scheduling of the base station 101.

For example, the base station 101 may transmit 90% of the total transmitted data to the relay equipment 103 at the transmission time t1 and the rest data (uᵢ) to the mobile station 105 at the transmission time t2. At this time, when the SNR or SINR of the link between the base station 101 and the mobile station 105 increases, the base station 101 may reduce the amount of data transmitted to the relay equipment 103 and increase the amount of data transmitted to the mobile station 105.

Furthermore, the base station 101 and the relay equipment 103 may transmit signals expressed as Equation 18 below. At this time, since the base station 101 and the relay equipment 103 transmit the same data \tilde{w}ᵢ at the transmission time t2, the received signals may be coherently combined in the mobile station 105.

x_{1,t1}=\sqrt{P₁}wᵢ

x_{1,t2}=\sqrt{αP₁}\tilde{w}ᵢ

x_{2,t2}=\sqrt{α̅P₁}\tilde{w}ᵢ Eq. 18

The embodiments of the present invention have been described in terms of the process. However, the respective steps composing the data transmission and reception methods of the base station, the relay equipment, and the mobile station in accordance with the embodiments of the present invention may be easily appreciated in terms of an apparatus. Therefore, the respective steps included in the data transmission and reception methods in accordance with the embodiments of the present invention may be understood as components included in the data transmitter and receiver, that is, the base station, the relay equipment, and the mobile station, respectively.

In accordance with the embodiments of the present invention, as the signals including independent code words are transmitted to the relay equipment and the receiver to perform cooperative communication, a high-level data transmission rate may be provided, and the implementation of the transmitter/receiver and the relay equipment may be facilitated.

The above-described methods can also be embodied as computer programs. Codes and code segments constituting the programs may be easily construed by computer programmers skilled in the art to which the invention pertains. Furthermore, the created programs may be stored in computer-readable recording media or data storage media and may be read out and executed by the computers. Examples of the computer-readable recording media include any computer-readable recoding media, e.g., intangible media such as carrier waves, as well as tangible media such as CD or DVD.

While the present invention has been described with respect to the specific embodiments, it will be apparent to those skilled in the art that various changes and modifications may be made without departing from the spirit and scope of the invention as defined in the following claims.

What is claimed is:

1. A data transmission method of a base station in a cooperative communication system, comprising:
generating a first code word for cooperative transmission and a second code word for direct transmission to a mobile station; and
transmitting a signal comprising one or more of the first and second code words to a relay equipment for cooperative transmission and the mobile station, and
wherein the first and second words are independent from each other.

2. The data transmission method of claim 1, wherein, in said transmitting a signal comprising one or more of the first and second code words to the relay equipment for cooperative transmission and the mobile station,
a signal comprising the first and second code words is transmitted to the relay equipment and the mobile station.

3. The data transmission method of claim 2, wherein the first code word comprises a plurality of code words having different indexes which are allocated depending on transmission times.

4. The data transmission method of claim 1, wherein said transmitting a signal comprising one or more of the first and second code words to the relay equipment for cooperative transmission and the mobile station comprises:
transmitting a signal comprising the first and second code words to the mobile station; and
transmitting a signal comprising the first code word to the relay equipment.

5. The data transmission method of claim 4, wherein, in said transmitting a signal comprising one or more of the first and second code words to the relay equipment for cooperative transmission and the mobile station,
the signal is transmitted to the relay equipment and the mobile station, respectively, using different frequencies or different transmission times.

6. The data transmission method of claim 5, wherein, in said transmitting a signal comprising the first code word to the relay equipment,
the first code word is re-encoded and transmitted to the relay equipment.

7. The data transmission method of claim 1, further comprising receiving channel information from the mobile station or the relay equipment,
wherein the transmitted signal is generated using the channel information.

8. The data transmission method of claim 1, wherein the relay equipment is a relay node or a base station of cells in accordance with Cooperative Multipoints Tx/Rx (CoMP).

9. A data transmission and reception method of a relay equipment in a cooperative communication system, comprising:
receiving a first signal transmitted from a base station, the first signal comprising one or more of a first code word for cooperative transmission and a second code word for direct transmission to a mobile station, and
transmitting a second signal comprising the first code word to the mobile station,
wherein the first and second code words are independent from each other.

10. The transmission and reception method of claim 9, wherein, in said transmitting a second signal comprising the first code word to the mobile station,
the first code word is re-encoded and transmitted to the mobile station.

11. The transmission and reception method of claim 9, further comprising receiving channel information from the mobile station,
wherein the second signal is generated using the channel information.

12. The transmission and reception method of claim 9, wherein the relay equipment is a relay node or a base station of cells in accordance with Cooperative Multipoints Tx/Rx (CoMP).

13. A data reception method of a mobile station in a cooperative communication system, comprising:
receiving a first signal transmitted from a base station, the first signal comprising one or more of a first code word for cooperative transmission and a second code word for direct transmission; and
receiving a second signal comprising the first code word from a relay equipment which cooperatively transmits the first signal,
wherein the first and second code words are independent from each other.

14. The data reception method of claim 13, further comprising transmitting channel information to the base station or the relay equipment.

15. A data transmission method of a base station in a cooperative communication system, comprising:
performing resource or time scheduling;
allocating resources or transmission times of links among the base station, a relay equipment and a mobile station in accordance with the scheduling; and
transmitting data to the relay equipment and the mobile station, respectively, depending on the allocated resources and transmission times.

16. The data transmission method of claim 15, wherein, in said performing resource or time scheduling,
channel information is used to perform the scheduling depending on a Signal-to-Noise Ratio (SNR) or Signal to Interference plus Noise Ratio (SINR) of the link among the base station, the relay equipment and the mobile station.

17. The data transmission method of claim 15, wherein, in said transmitting data to the relay equipment and the mobile station, respectively, depending on the allocated resources and transmission times,
the data depending on the allocated resources are transmitted to the relay equipment and the mobile station, respectively, at different transmission times.
